(19) United States
(12) Patent Application Publication
(10) Pub. No.: US 2019/0183088 A1
(43) Pub. Date: Jun. 20, 2019

(54) Pet carrier

(71) Applicant: Shanghai Bolu Pet Product Co., Ltd., Shanghai (CN)

(72) Inventor: Dawei Yang, Shanghai (CN)

(21) Appl. No.: 16/009,402

(22) Filed: Jun. 15, 2018

(30) Foreign Application Priority Data
Dec. 19, 2017 (CN) 201711371579.2

(51) Int. Cl. A01K 1/02; A01K 1/00

(52) U.S. Cl. CPC A01K 1/029; A01K 1/0064

(57) ABSTRACT

The present invention provides a pet carrier including a carrier body. The carrier body including a translucent part and an opaque part. The carrier body is provided with a breathable structure and a first opening for a pet to enter and exit the carrier body. The pet carrier further includes a first leaf for covering the first opening. The translucent part and opaque part are design for the pet to stay in either one by its own will. Because of pet's visual limitations, the use of frosted material of the translucent part of the pet carrier prevents the pet from seeing the strange environment and from being fear. However, the user can still see the pet in the pet carrier. In addition, the breathable structure of the pet carrier ensures that the pet carrier is fully breathable.

### BACKGROUND OF INVENTION

The present invention relates to a pet product and, more particularly, to a pet carrier.

As pet consumption escalates, more and more pet bags enter the market, and pet bags have also become travel articles. The existing pet bags can be roughly divided into two types: one type is that the pet is placed in a completely enclosed structure. Pets cannot observe outside. Not only the pet easily feel irritable or fear, but also the owner cannot observe the pet's situation. The other type is the backpack with a transparent protective cover, which let pet observe outside, but the pet still easy to feel excited or frightened. Furthermore, it is inconvenient to release the pet, or comfort the pet in the trip. Therefore, the current pet bag is only suitable for short trip because of the structural limitation, which limits the use of pet bag.

### SUMMARY OF THE INVENTION

The present invention provides a pet carrier for solving the problem that the existing pet bags cause anxiety or fear of the pet easily and can only be used for a short trip.

In order to achieve the aforementioned functions, there provides a pet carrier including a carrier body. The carrier body including a translucent part and an opaque part. The carrier body is provided with a breathable structure and a first opening for a pet to enter and exit the carrier body. The pet carrier further includes a first leaf for covering the first opening.

The translucent part and opaque part are design for the pet to stay in either one by its own will. Considering the habit of the pet to hide in the unfamiliar environment, staying in the pet carrier can effectively relieve the pet from resulting in fear, anxiety and other emotions when one carries the pet out. Because of pet's visual limitations, the use of frosted material of the translucent part of the pet carrier prevents the pet from seeing the strange environment and from being fear, anxiety and other emotions. However, the user can still see the pet in the pet carrier and can meet the requirement of the owner to observe the pet. In addition, the breathable structure of the pet carrier ensures that the pet carrier is fully breathable.

Based on the above technical solutions, the present invention can also make the following improvements:

As a further improvement of the present invention, the pet carrier further comprises a knob mounted on the carrier body, wherein the first leaf is connected with the knob and rotated synchronously with the knob. The first leaf is covering the first opening when the knob is at a first position. The first leaf is received in the carrier body and let the first opening open when the knob is at a second position.

In one embodiment of the pet carrier, wherein the first leaf is sliding against with the carrier body. The first leaf is covering the first opening when the first leaf slides to a first position. The first opening is opened when the first leaf slides to a second position.

By adopting the above technical solutions, each one of these two ways to open the first leaf is easy to operate and easy to realize. The first leaf is not only easy to operate through the knob, but also can hide itself into the carrier body. This technical solution is not only beautiful but also avoids the pet from bumping into the first leaf and causing damage when the pet enters and leaves the pet carrier.

In one embodiment of the pet carrier, wherein the translucent part and the opaque part are sleeved together with an overlapping part.

By adopting the above technical solution, the internal accommodating space of the pet carrier can be maximally increased, and pets of different sizes can be suitable to the pet carrier.

In one embodiment of the pet carrier, wherein the overlapping part of the translucent part is provided with the first opening, and the overlapping part of the opaque part is provided with the first leaf. Or the overlapping part of the opaque part is provided with the first opening, and the overlapping part of the translucent part is provided with the first leaf. The translucent part and the opaque part are sliding with each other to open the first opening or to close the first opening.

By adopting the above technical solution, the opening and closing of the first opening is realized by overlapping and separating the overlapping part. The characteristic of the overlapping part is fully utilized, and the structure is ingenious.

In one embodiment of the pet carrier, wherein the upper part of the carrier body is provided with a through hole for allowing human hand to enter, and the carrier body is provided with a hole cover for covering the through hole.

With the above technical solution, the pet's owner can comfort and interact with the pet through the through hole to further reduce the pet's anxiety.

In one embodiment of the pet carrier, wherein the hole cover is hinged or slidably fitted or screwed or snap-connected the through hole or connected by a zipper structure.

These covering methods are not only simple in structure, but also can prevent the pet from opening the hole cover.

In one embodiment of the present invention, the pet carrier further provides a second opening on the carrier body away from the first opening and a second leaf for covering the second opening, wherein the second opening is larger than the first opening.

According to the above technical solution, the second opening with a size larger than the size of the first opening is provided on the opposite side of the first opening. The second opening facilitates the pet owner to clean the excrement in the pet carrier and also provides a way to forcibly pull out the pet when it is unwilling to leave the pet carrier.

In one embodiment of the pet carrier, wherein one end of the second leaf is hinged with the carrier body, and the other end is connected with the carrier body through a lock assembly.

With the above technical solution, not only the hinge structure facilitates the opening and closing of the second leaf, but also the lock assembly prevents the pet from opening the second leaf and improves safety.

In one embodiment of the pet carrier, wherein the breathable structure is a plurality of air-permeable holes or air-permeable grills provided on the opaque part of the carrier body.

With the above technical solution, the breathable structure is designed as a plurality of air-permeable holes or air-permeable grilles which is simple in structure and easy to produce. In addition, considering that the pet is usually staying in the translucent part for a long time, the air-permeable hole or the air-permeable grilles are provided on the opaque part for fully adapted to pet habits.

In one embodiment of the present invention, the pet carrier further comprises a groove on the top of the carrier body, a handle, and a seat belt buckle both hidden in the groove, wherein one end of the handle is connected with the bottom surface of the groove by a torsion spring, the other end of the handle is connected with the seat belt buckle, and the other end of the seat belt buckle is hinged with the carrier body.

The embodiment of the invention has the technical scheme that the handle is convenient for the user to carry the pet carrier and the seat belt buckle is convenient for the user to connect the pet carrier and the seat belt to improve the safety. The handle and the seat belt buckle can be hidden in the groove through the torsion spring when the user let go the handle. The handle and the seat belt buckle can be simultaneously turned and popped up conveniently by the technical scheme.

Additional aspects and advantages of the invention will be described in the description which follows in part, and be apparent from the description in part, or be realized from the practice of the invention.

### BRIEF DESCRIPTION OF THE DRAWINGS

The present invention will now be specified with reference to its preferred embodiment illustrated in the drawings, in which:

FIG. 1 is a schematic side view of the structure of a pet carrier of an embodiment of the present invention.

FIG. 2 is a schematic side view of the structure of a pet carrier of an embodiment of the present invention.

FIG. 3 is a schematic front view of the structure of a pet carrier of an embodiment of the present invention.

FIG. 4 is a schematic rear view of the structure of a pet carrier of an embodiment of the present invention.

FIG. 5 is a schematic top view of the structure of a pet carrier of an embodiment of the present invention.

FIG. 6 is a schematic bottom view of the structure of a pet carrier of an embodiment of the present invention.

FIG. 7 is a schematic side view of the structure of a pet carrier of another embodiment of the present invention.

FIG. 8 is a schematic side view of the structure of a pet carrier of another embodiment of the present invention.

FIG. 9 is a schematic front view of the structure of a pet carrier of another embodiment of the present invention.

FIG. 10 is a schematic rear view of the structure of a pet carrier of another embodiment of the present invention.

FIG. 11 is a schematic top view of the structure of a pet carrier of another embodiment of the present invention.

FIG. 12 is a schematic bottom view of the structure of a pet carrier of another embodiment of the present invention.

FIG. 13 is a first leaf of a pet carrier of an embodiment of the present invention.

FIG. 14 is another first leaf of a pet carrier of an embodiment of the present invention.

FIG. 15 is a schematic view of the structure of a hole cover of the pet carrier of an embodiment of the present invention.

FIG. 16 is a schematic view of the structure of another hole cover of the pet carrier of an embodiment of the present invention.

FIG. 17 is a schematic view of the structure of still another hole cover of the pet carrier of an embodiment of the present invention.

FIG. 18 is a schematic view of the structure of still another hole cover of the pet carrier of an embodiment of the present invention.

FIG. 19 is a schematic view of the structure of still another hole cover of the pet carrier of an embodiment of the present invention.

FIG. 20 is a schematic view of the structure of still another hole cover of the pet carrier of an embodiment of the present invention.

### DESCRIPTION OF THE INVENTION

The principles and features of the invention will be described below with reference to the drawings. The same or similar reference numerals denote the same or similar elements or elements having the same or similar functions. It should be understood that the specific embodiments described herein are merely illustrative of the invention and are not intended to limit the invention.

In the description, it should be understood that the terms “longitudinal”, “horizontal”, “upper”, “lower”, “front”, “rear”, “left”, “right”, “Horizontal”, “top”, “bottom”, “inside”, “outside” and the like are based on the orientation or positional relationship shown in the drawings only for the purpose of describing the invention, it is not instructions or implied means that the device or element must have a specific orientation, constructed and operated in a particular orientation, and therefore it should not be construed as limiting the invention.

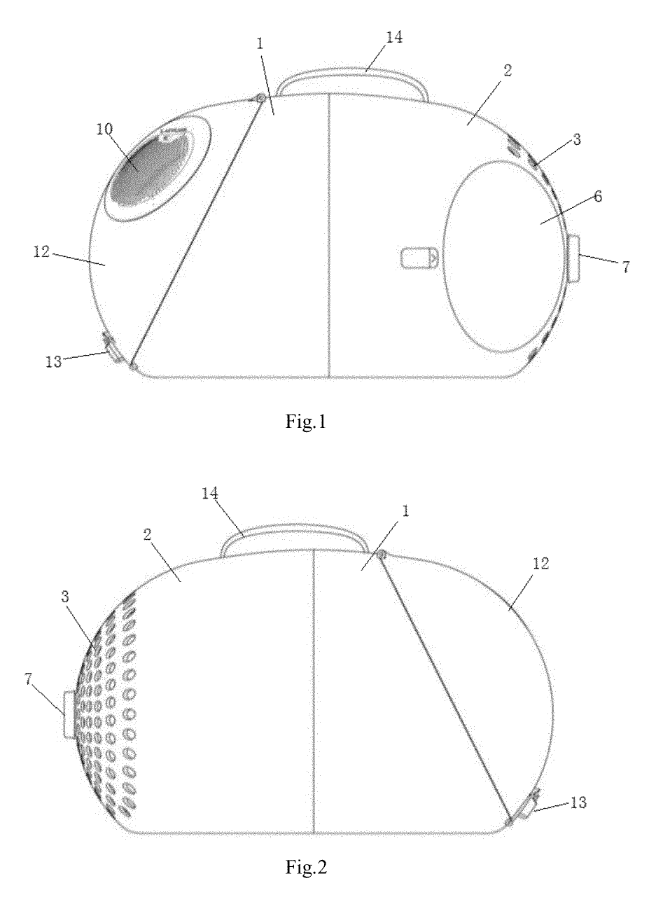

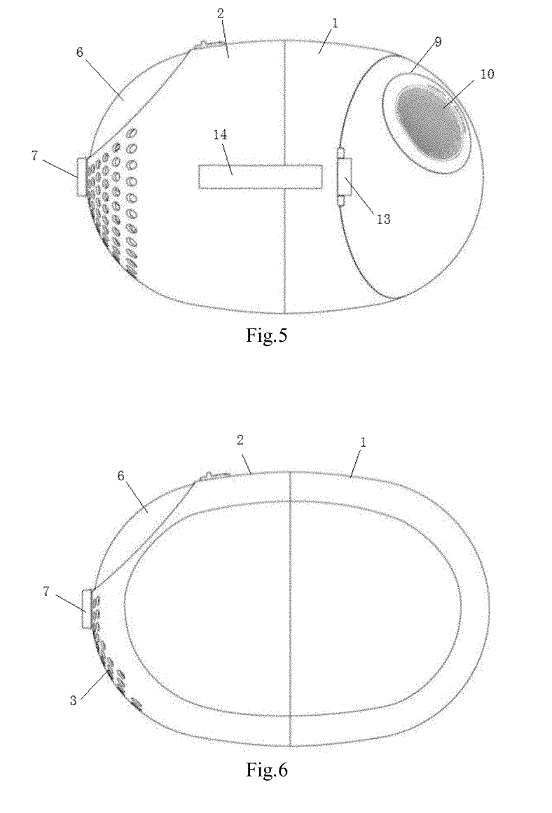

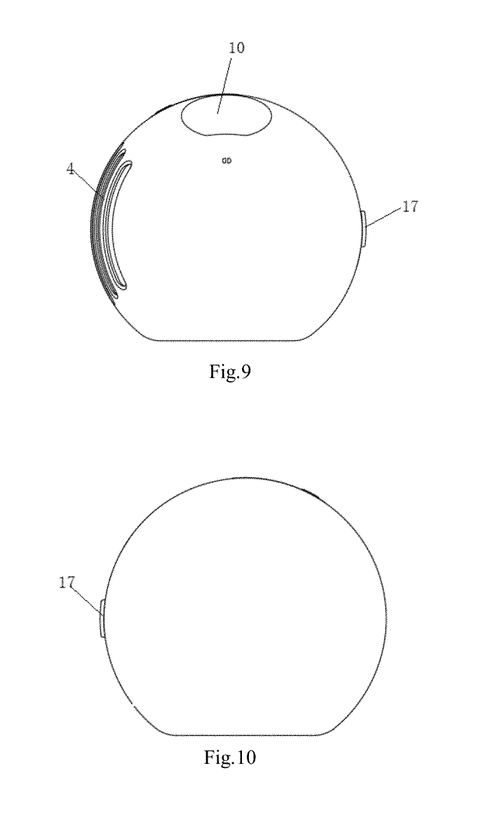

As shown in FIGS. 1 to 20, one embodiment of the invention provides a pet carrier includes a carrier body. The carrier body including a translucent part 1 and an opaque part 2 connected together. The translucent part 1 takes into account the limits of vision and ability of discrimination of color between human and pet. After a large number of experiments, the inventor found that when the opacity of the translucent part 1 is 25%˜30%, the pet cannot see through the translucent part 1, but pet owners can still clearly see the pets in the pet carrier. Specifically, the material of the translucent part 1 of the embodiment is plastic having a frosted surface, or other frosted material, or material with frosted surface. The translucent part 1 and the opaque part 2 are design for the pet to stay in either one by its own will. Considering the habit of the pet to hide in the unfamiliar environment, staying in the pet carrier can effectively relieve the pet from resulting in fear, anxiety and other emotions when one carries the pet out. Because of pet's visual limitations, the use of frosted material of the translucent part 1 of the pet carrier prevents the pet from seeing the strange environment and from being fear, anxiety and other emotions. However, the user can still see the pet in the pet carrier and this meets the requirement of the owner to observe the pet. In addition, the pet carrier can also be used as a pet house at home.

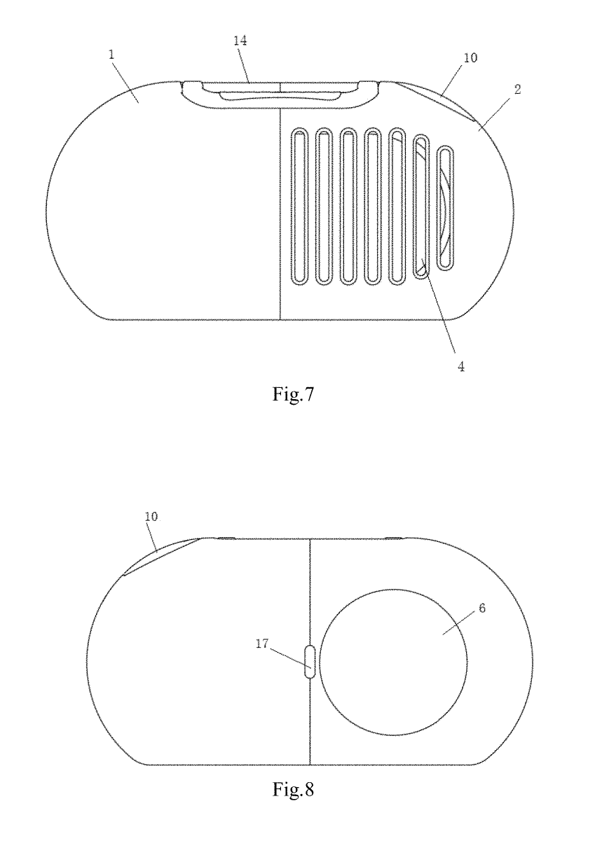

In one embodiment of the invention, the pet carrier looks like a capsule or other shape. The breathable structure on the body is designed as a plurality of air-permeable holes 3 as FIG. 1, 4, or 5, or air-permeable grilles 4 as FIG. 7. The breathable structure is ensured the full ventilation of the pet carrier. In one embodiment, the breathable structure is provided on the opaque part 2. The breathable structure such as a plurality of air-permeable holes 3 or air-permeable grilles 4 is simple in structure and easy to produce. In addition, considering that the pet is usually staying in the translucent part 1 for a long time, the air-permeable holes 3 or the air-permeable grilles 4 are provided on the opaque part 2 for fully adapted to pet habits.

The carrier body is provided with a first opening 5 and a first leaf 6 for covering the first opening 5. The pet enters and exits the carrier body through the first opening 5. There provide several ways for the first leaf 6 connected the first opening 5.

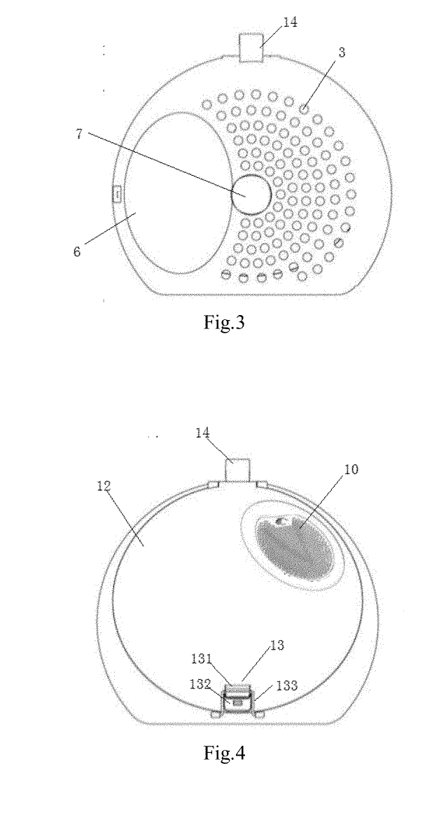

Please refer to FIGS. 2 and 3, the pet carrier further comprises a knob 7 mounted on the carrier body, wherein the first leaf 6 is connected with the knob 7 and rotated synchronously with the knob 7. The first leaf 6 is covering the first opening 5 and locking the first opening 5 by a lock or snap when the knob 7 is rotated to a position. The first leaf 6 is received in the carrier body and let the first opening 5 open when the first leaf 6 is rotated with knob 7 again. The first leaf 6 is not only easy to operate through the knob 7, but also can hide itself into the carrier body. This technical solution is not only beautiful but also avoids the pet from bumping into the first leaf 6 and causing damage when the pet enters and leaves the pet carrier.

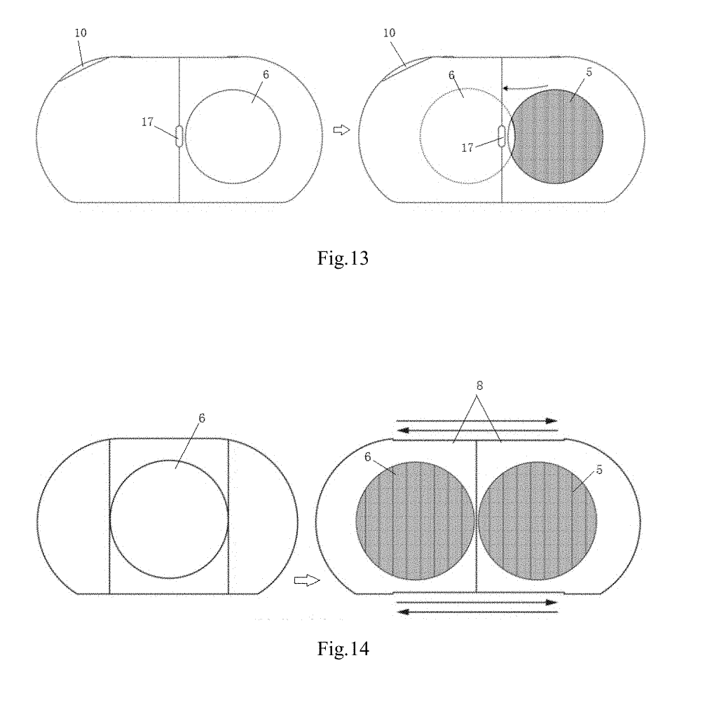

Please refer to FIG. 13. The first leaf 6 is sliding against with the carrier body. The first leaf 6 is covering the first opening 5 when the first leaf 6 slides to a first position and locking by a switch button 17. The first opening 5 is opened when the first leaf 6 slides to a second position. This structure is easy to operate and easy to realize.

Please refer to FIG. 14. In one embodiment of the invention, the translucent part 1 and the opaque part 2 are sleeved together with an overlapping part 8. The overlapping part 8 of the translucent part 1 is provided with the first opening 5, and the overlapping part 8 of the opaque part 2 is provided with the first leaf 6. Or the overlapping part 8 of the opaque part 2 is provided with the first opening 5, and the overlapping part 8 of the translucent part 1 is provided with the first leaf 6. The translucent part 1 and the opaque part 2 are sliding with each other to open the first opening 5 or to close the first opening 5. It should be noted that even when the translucent part 1 and the opaque part 2 are sliding away to open the first opening 5, the translucent part 1 and the opaque part 2 are still connected together somewhere. By adopting the above technical solution, the internal accommodating space of the pet carrier can be maximally increased, and pets of different sizes can be suitable to the pet carrier. The opening and closing of the first opening 5 is realized by overlapping and separating the first leaf 6 by sliding the overlapping part 8, and the characteristic of the overlapping part 8 is fully utilized, and the structure is ingenious.

In one embodiment of the invention, the upper part of the carrier body is provided with a through hole 9 for allowing human hand to enter, and the carrier body is provided with a hole cover 10 for covering the through hole 9. The pet's owner can comfort and interact with the pet through the through hole 9 during the trip to further reduce the pet's anxiety.

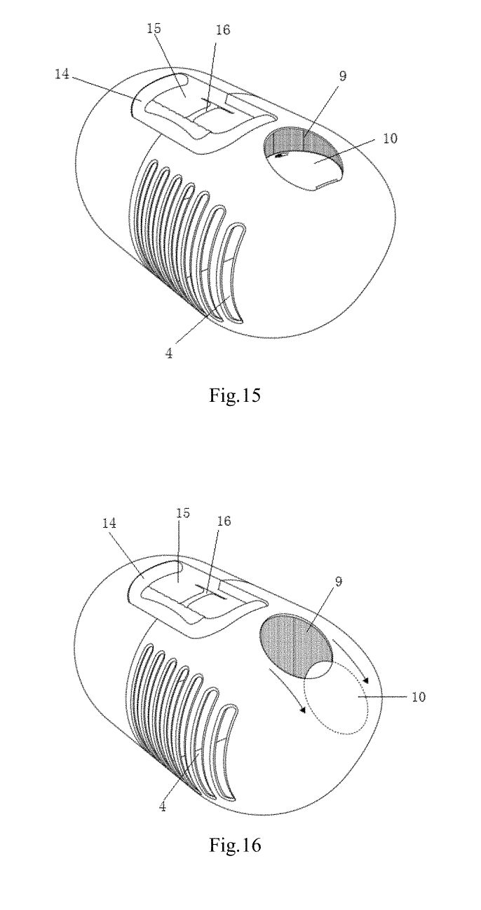

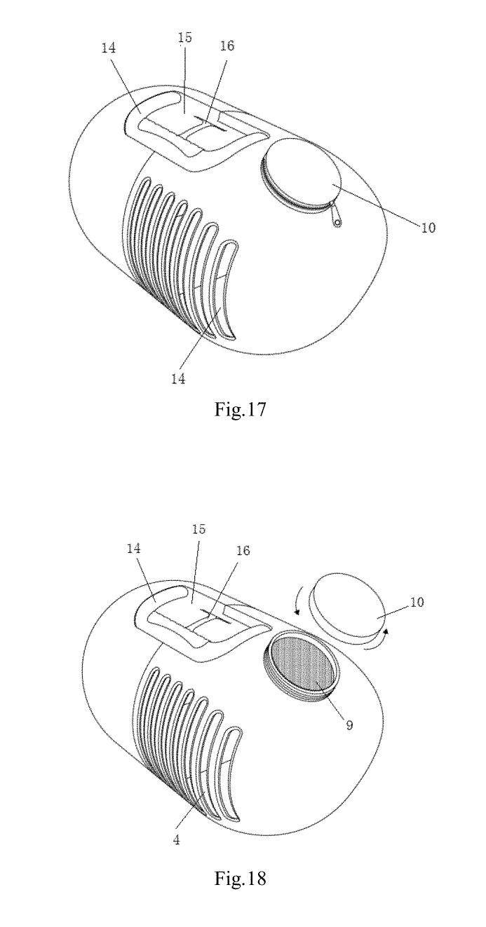

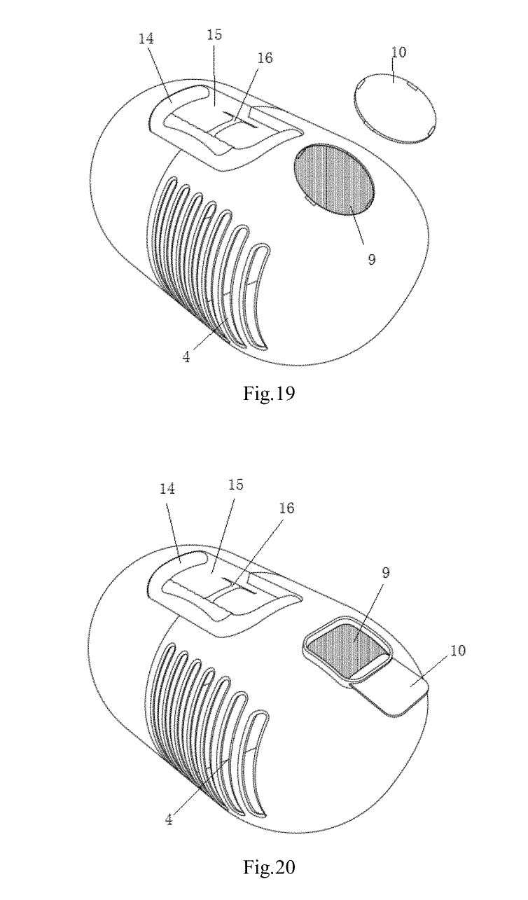

There provide several way for the hole cover 10 connected the through hole 9. Please refer to FIG. 15. The hole cover 10 is hinged the through hole 9 by a structure having recovery function such as a torsion spring. Please refer to FIG. 16. In another embodiment, the hole cover 10 is sliding against the carrier body and receiving within the carrier body. Please refer to FIG. 17. In another embodiment, the hole cover 10 and the through hole 9 are connected by a zipper structure. Please refer to FIG. 18. In another embodiment, the hole cover 10 is screwed with the through hole 9. The through hole 9 may be provided with an external thread, and the hole cover 10 may be provided with an internal thread adapted to the external thread. Of course, the through hole 9 may be provided with an internal thread, and the hole cover 10 may be provided with an external thread. Please refer to FIG. 19. In another embodiment, the hole cover 10 is snap-connected the through hole 9. Please refer to FIG. 20. In another embodiment, the hole cover 10 is sliding against the through hole 9 with a structure like a drawer. These covering methods are not only simple in structure, but also can prevent the pet from opening the through hole.

In one embodiment of the present invention, in order to facilitate the pet owner to clean the excrement in the pet carrier and also to provide a way to forcibly pull out the pet when it is unwilling to leave the pet carrier, the pet carrier further comprises a second opening 11 on the carrier body away from the first opening 5 and a second leaf 12 for covering the second opening 11, wherein the second opening 11 is not only larger than the first opening 5, but also larger than the maximum cross-sectional size of the carrier body as shown in FIGS. 1 and 2. Please refer to FIGS. 1 to 6. The hole cover 10 of the through hole 9 may be provided on the second leaf 12. One end of the second leaf 12 is hinged with the carrier body, and the other end is connected with the carrier body through a lock assembly 13. The lock assembly 13 includes a rotatable first locking portion 131 disposed at the bottom of the second leaf 12, a buckle 132 disposed at the bottom of the second leaf 12, and a rotatable second locking portion 133 disposed at the bottom of the second opening 11. The second locking portion 133 is rotated so that one end thereof is placed in the groove of the buckle 132, and the first locking portion 131 is rotated to be engaged with the buckle 132 to fix the second locking portion 133. Of course, other lock assembly 13 known in the art may also be used in this embodiment, which will not be described in detail here. Not only the hinge structure facilitates the opening and closing of the second leaf, but also the lock assembly prevents the pet from opening the second leaf and improves safety.

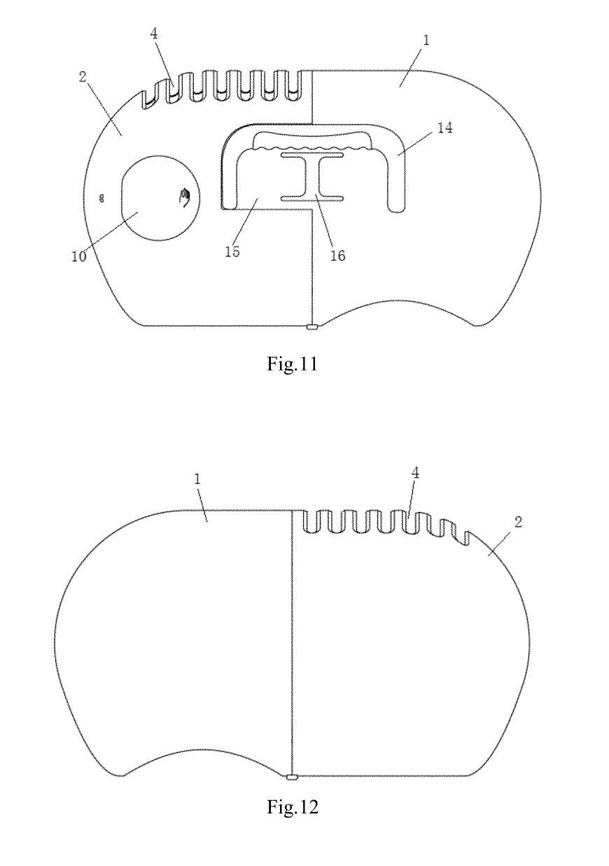

In addition, in order to carry the pet carrier conveniently, there is provided a handle 14 mounted on the carrier body in this embodiment. The handle 14 may be a simple handle structure as shown in FIG. 1 or 2, or may be a handle structure as shown in FIGS. 11, and 15-20. The structure comprises a groove 15 on the top of the carrier body, a handle 14, and a H-type seat belt buckle 16 both hidden in the groove 15, wherein two ends of the C-shape handle 14 are connected with the bottom surface of the groove 15 by recovering structures such as torsion springs. One end of the H-type seat belt buckle 16 is connected with the handle 14, and the other end of the H-type seat belt buckle 16 is hinged with the carrier body. On the other hand, the connection of torsion springs may change to the H-type seat belt buckle 16, that is, the two ends of the H-type seat belt buckle 16 are connected with the bottom surface of the groove 15 by torsion springs. The upper end of the handle 14 and the upper ends of the H-type seat belt buckle 16 are connected together. The lower ends of the handle 14 are hinged with the carrier body. In this structure, the H-type seat belt buckle 16 can be rotated associated with the handle 14 in the groove 15 and the H-type seat belt buckle 16 can be rotated out from the groove 15 while the handle 14 hidden in the groove 15 is rotated out. The handle 14 is convenient for the user to carry the pet carrier and the seat belt buckle 16 is convenient for the user to connect the pet carrier and the seat belt to improve the safety. The handle 14 and the seat belt buckle 16 can be hidden in the groove 15 through the torsion spring when the user let go the handle 14. The handle 14 and the seat belt buckle 16 can be simultaneously turned and popped up from or received in the groove 15 conveniently by the technical scheme.

The marks in figures are described as follows: 1 translucent part, 2 opaque part, 3 air-permeable holes, 4 air-permeable grills, 5 first opening, 6 first leaf, 7 knob, 8 overlapping part, 9 through hole, 10 hole cover, 11 second opening, 12 second leaf, 13 lock assembly, 131 first locking part, 132 buckle, 133 second locking part, 14 handle, 15 groove, 16 H-type seat belt buckle, 17 switch button.

In the present invention, the terms “mounted”, “connected”, “connected”, “fixed” and the like should be broadly understood unless expressly stated and limited otherwise. For example, it may be fixed or connected detachably or integral with each other. Or it may be a mechanical connection or an electrical connection. Or it may be directly connected or indirectly connected through an intermediary medium. Or it may be an interconnection between two elements or an interaction between two elements unless otherwise specified. For those skilled in the art, the specific meanings of the above terms in the present invention may be understood based on specific situations.

In the present invention, unless expressly stated or limited otherwise, the first feature is above or below the second feature may mean that the first feature may be in direct contact with the second feature or the first and second features are indirectly in contact with each other through an intermediary contact. Furthermore, the first feature is “on”, “above” and “over” the second feature may mean that either the first feature is directly above or obliquely above the second feature or merely indicates that the level of the first feature is higher than the level of the second feature. The first feature is “under”, “below” and “beneath” the second feature may mean that either the first feature is directly below or obliquely below the second feature or simply indicating that the level of the first feature is less than the level of the second feature.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present invention, “a plurality of” means at least two, for example, two, three, etc., unless expressly limited otherwise.

In the description of the specification, the description of the terms “one embodiment,” “some embodiments,” “an example,” “a specific example,” or “some examples” and the like means the specific features, structures, materials, or features described in that embodiment or example are included in at least one embodiment or example of the invention. In the present specification, a schematic expression of the above terms does not necessarily refer to the same embodiment or example. Furthermore, the particular features, structures, materials, or characteristics described may be combined in any suitable manner in any one or more of the embodiments or examples. In addition, different embodiments or examples described in this specification and features of different embodiments or examples may be combined by those skilled in the art without mutual contradiction.

The above description is a preferred embodiment of the invention. And it should be noted that it will be apparent to those skilled in the art that a number of improvements and modifications may be made without departing from the principles of the invention. These improvements and modifications also regarded as the scope of protection of the invention.

What is claimed is:

1. A pet carrier, comprising:
a carrier body with a translucent part and an opaque part;
a breathable structure on said carrier body;
a first opening on said carrier body for a pet to enter and exit; and
a first leaf for covering said first opening.

2. The pet carrier of claim 1, further comprising a knob mounted on the carrier body, wherein said first leaf is connected with said knob and rotated synchronously with said knob, said first leaf is covering said first opening when said knob is at a first position, and said leaf is received in said carrier body when said knob is at a second position.

3. The pet carrier of claim 1, wherein said first leaf is sliding against with said carrier body and said first leaf is covering said first opening when said first leaf slides to a first position and said first opening is opened when said first leaf slides to a second position.

4. The pet carrier of claim 1, wherein said translucent part and said opaque part are sleeved together with an overlapping part.

5. The pet carrier of claim 4, wherein said overlapping part of said translucent part is provided with said first opening, and said overlapping part of said opaque part is provided with said first leaf or said overlapping part of said opaque part is provided with said first opening, and said overlapping part of said translucent part is provided with said first leaf and said translucent part and said opaque part are sliding with each other to open or to close said first opening.

6. The pet carrier of claim 1, wherein the upper part of said carrier body is provided with a through hole for allowing human hand to enter, and said carrier body is provided with a hole cover for covering said through hole.

7. The pet carrier of claim 6, wherein said hole cover is hinged or slidably fitted or screwed or snap-connected said through hole or connected by a zipper structure.

8. The pet carrier of claim 1, further comprising a second opening on said carrier body away from said first opening and a second leaf for covering said second opening, wherein said second opening is larger than said first opening.

9. The pet carrier of claim 8, wherein one end of said second leaf is hinged with said carrier body, and the other end is connected with said carrier body through a lock assembly.

10. The pet carrier of claim 1, wherein said breathable structure is a plurality of air-permeable holes or air-permeable grills provided on said opaque part of said carrier body.

11. The pet carrier of claim 1, further comprising a groove on the top of said carrier body, a handle, and a seat belt buckle hidden in said groove, wherein one end of said handle is connected with the bottom surface of said groove by a torsion spring, the other end of said handle is connected with said seat belt buckle, and the other end of said seat belt buckle is hinged with said carrier body.

12. The pet carrier of claim 2, further comprising a second opening on said carrier body away from said first opening and a second leaf for covering said second opening, wherein said second opening is larger than said first opening.

13. The pet carrier of claim 3, further comprising a second opening on said carrier body away from said first opening and a second leaf for covering said second opening, wherein said second opening is larger than said first opening.

14. The pet carrier of claim 4, further comprising a second opening on said carrier body away from said first opening and a second leaf for covering said second opening, wherein said second opening is larger than said first opening.

15. The pet carrier of claim 5, further comprising a second opening on said carrier body away from said first opening and a second leaf for covering said second opening, wherein said second opening is larger than said first opening.

16. The pet carrier of claim 6, further comprising a second opening on said carrier body away from said first opening and a second leaf for covering said second opening, wherein said second opening is larger than said first opening.

17. The pet carrier of claim 7, further comprising a second opening on said carrier body away from said first opening and a second leaf for covering said second opening, wherein said second opening is larger than said first opening.

18. The pet carrier of claim 2, wherein said breathable structure is a plurality of air-permeable holes or air-permeable grills provided on said opaque part of said carrier body.

19. The pet carrier of claim 3, wherein said breathable structure is a plurality of air-permeable holes or air-permeable grills provided on said opaque part of said carrier body.

20. The pet carrier of claim 4, wherein said breathable structure is a plurality of air-permeable holes or air-permeable grills provided on said opaque part of said carrier body.
